(19) United States
(12) Patent Application Publication
(10) Pub. No.: US 2024/0370254 A1
(43) Pub. Date: Nov. 7, 2024

(54) MANAGEMENT OF MODELS IN A FACILITY MONITORING SYSTEM USING CONTAINERIZATION

(71) Applicant: Woodside Energy Technologies Pty Ltd, Perth (AU)

(72) Inventor: Darren Andrew TAYLOR, Shenton Park (AU)

(21) Appl. No.: 18/774,329

(22) Filed: Jul. 16, 2024

Related U.S. Application Data
(63) Continuation of application No. 15/902,159, filed on Feb. 22, 2018.

(30) Foreign Application Priority Data
Feb. 22, 2017 (AU) 2017900591

(51) Int. Cl. G06F 8/71; G05B 19/042; G06F 8/35; G06Q 10/063; G06Q 10/067; G06Q 50/06

(52) U.S. Cl. CPC G06F 8/71; G06F 8/35; G06Q 10/063; G06Q 10/067; G05B 19/042; G06Q 50/06

(57) ABSTRACT

A model management system manages models that carry out at least one function on data obtained from at least one tag. The system stores data indicative of a plurality of model modules, each model module configured to implement core functionality of a model, and data indicative of a plurality of non-core functions, each non-core function configured to implement non-core functionality of a model. The system also stores a plurality of application containers, each application container including components required to execute a model and each application container defining a computing environment suitable for implementing the model. A model implementer implements a model by implementing at least one model module defined for the model and implementing at least one non-core function defined for the model, and the model implementer can further implement the model using a stateless container suitable for implementing the model.

### CROSS-REFERENCE TO RELATED APPLICATION

This application is a continuation of U.S. patent application Ser. No. 15/902,159, filed Feb. 22, 2018, which claims priority to Australian Patent Application No. 2017900591, filed Feb. 22, 2017, the disclosures of which are incorporated herein by reference in their entireties.

### FIELD

The present invention relates to a model management system.

### BACKGROUND

In a typical production plant, such as a gas production plant, it is common for the plant to include a large number of ‘tags’, typically in the form of sensors, that each provide operational information indicative of the operational state of an aspect of the plant as a time series record.

During operation of the plant, it is necessary to repeatedly query the tags using one or more software models so that operators of the plant are provided with important information about the plant for monitoring and reporting purposes, and for use in business decision making. Example models include a model for querying a high pressure gas flow rate sensor and determining whether a sequence of values obtained by the sensor are plausible, thereby providing an indication as to whether the sensor is functioning correctly.

In a conventional model management system, a large number of models are developed using typical computing environments such as R, python and matlab, then implemented in a deployment system. Each model commonly includes deployment code and functional code corresponding to core functionality and non-core functionality.

In order to implement a new model or implement a modified existing model, it is necessary to first successfully pass through a quality control process whereby the entire model code is reviewed and approved by authorised personnel. However, this process is time consuming and cumbersome to the extent that large scale deployment and maintenance of code across a plant is impractical.

### SUMMARY

The inventors have appreciated that in a typical model code it is not uncommon for a small number of functional lines of code to be embedded within a large number of lines of deployment code, but despite this the entire model code must be analysed and ultimately approved as part of the quality control process.

In accordance with a first aspect of the present invention, there is provided a model management system for managing models arranged to carry out at least one function on data obtained from at least one tag, each tag arranged to produce data associated with operation of a process;
the system arranged to store data indicative of a plurality of model modules, each model module configured to implement core functionality of a model, and data indicative of a plurality of non-core functions, each non-core function configured to implement non-core functionality of a model;
the system arranged to store a plurality of application containers, each application container including components required to execute a model and each application container defining a computing environment suitable for implementing the model; and the system comprising a model implementer arranged to implement a model by implementing at least one model module defined for the model and implementing at least one non-core function defined for the model; and the model implementer arranged to implement the model using an application container suitable for implementing the model.

In an embodiment, the system is arranged to store model parameters records, each model parameters record including information indicative of at least one model module to be implemented for a model.

In an embodiment, each model parameters record includes information indicative of one model module to be implemented for a model. Alternatively, at least one model parameters record includes information indicative of a plurality of model modules to be implemented for the model.

In an embodiment, at least one model module is associated with multiple model parameter records such that multiple model parameters records include information indicative of the same model module.

In an embodiment, each model parameters record is indicative of at least one non-core function to be implemented for the model.

In an embodiment, each model parameters record includes timing information indicative of when the model associated with the model parameters record is to be implemented. The timing information may include information indicative of the frequency at which the model is to be implemented.

In an embodiment, each model parameters record includes information indicative of whether the model associated with the model parameters record is active or inactive, wherein the model implementer does not implement the model when the model parameters record includes an inactive indication.

In an embodiment, the system comprises a scheduler arranged to schedule implementation of the models associated with the model parameters records. The scheduler may be arranged to implement the models associated with the model parameters records using the timing information in the model parameters records.

In an embodiment, the application container is a stateless container.

In an embodiment, the system comprises a model inputs data storage component arranged to store input data to be used by at least one model implemented by the model implementer. The input data may be obtained from at least one tag, and the system may comprise a data gatherer arranged to obtain input data from the at least one tag and store the data in the model inputs data storage component.

The model inputs data storage component may comprise one model inputs database arranged to store input data obtained from multiple tags for use by multiple models. Alternatively, the model inputs data storage component may comprise multiple model inputs databases, for example a model inputs database for each tag, a model inputs database for each model or a model inputs database for each model module.

In an embodiment, the system comprises a model outputs data storage component arranged to store output data produced by implementation of at least one model module.

The model outputs data storage component may comprise one model outputs database for storing output data produced by implementation of multiple model modules. Alternatively, the model outputs data storage component may comprise multiple outputs databases, for example a multiple outputs database for each model or a model outputs database for each model module.

In an embodiment, the system comprises at least one model data storage component arranged to store input data to be used by at least one model module implemented by the model implementer and output data produced by implementation of the model module.

In an embodiment, the system applies a model outputs data storage naming convention for model versions that assures a unique output set per model-version key pair.

The key pair unique output arrangement of data storage permits at least one model development version to coexist with an active approved model. It will be understood that a common eco-system for development, test and production versions of a model reduces deployment to selection of which models are active. In contrast, traditional model management systems require lengthy deployment procedures to transfer new models to production servers, with a risk that deployment issues will be encountered, for example because the new model is inconsistent with the development environment.

In an embodiment, at least one model module is arranged to implement core functionality using input data obtained from one tag.

In an embodiment, at least one model module is arranged to implement core functionality using input data obtained from multiple tags.

In an embodiment, at least one model module is arranged to implement one core function using input data obtained from at least one tag.

In an embodiment, at least one model module is arranged to implement multiple core functions using input data obtained from at least one tag.

In an embodiment, at least one tag includes a sensor.

In an embodiment, a core function includes an analysis, validation and/or thresholding function in relation to data obtained from at least one tag.

In an embodiment, the system includes a module editor arranged to facilitate creation and/or modification of a model module.

In accordance with a second aspect of the present invention, there is provided a method of managing models arranged to carry out at least one function on data obtained from at least one tag, each tag arranged to produce data associated with operation of a process, the method comprising:
storing data indicative of a plurality of model modules, each model module configured to implement core functionality of a model, and data indicative of a plurality of non-core functions, each non-core function configured to implement non-core functionality of a model;
storing a plurality of application containers, each application container including components required to execute a model and each application container defining a computing environment suitable for implementing the model; and
using a model implementer to implement a model by implementing at least one model module defined for the model and implementing at least one non-core function defined for the model;
wherein the model implementer implements the model using an application container suitable for implementing the model.

### BRIEF DESCRIPTION OF THE DRAWINGS

The present invention will now be described, by way of example only, with reference to the accompanying drawings, in which:

FIG. 1 is a diagrammatic block diagram of a model management system in accordance with an embodiment of the present invention;

FIGS. 2a, 2b and 2c show an example plot of tag data for an example tag in a gas processing plant during normal operation of the tag, and example plots of tag data for an example tag in a gas processing plant during abnormal operation of the tag;

FIG. 3 is a representation of a model parameters record stored in a model parameters database of the system shown in FIG. 1;

FIG. 4 is a representation of an input record stored in a model inputs database of the system shown in FIG. 1;

FIG. 5 is a representation of an output record stored in a model outputs database of the system shown in FIG. 1; and

FIG. 6 is a flow diagram illustrating steps of a model management process in accordance with an embodiment of the present invention.

### DETAILED DESCRIPTION

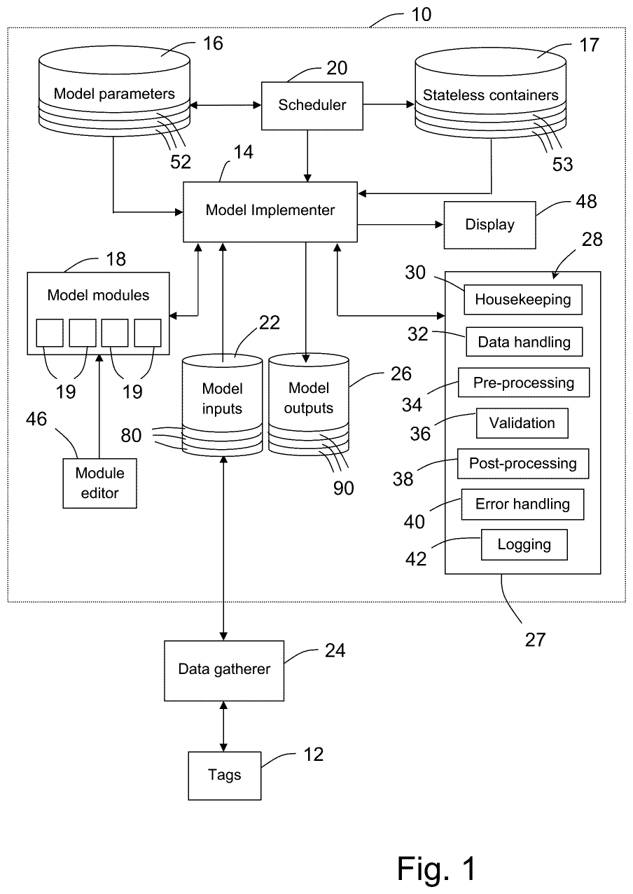

Referring to FIG. 1 of the drawings, an example model management system 10 is shown, in this example for use with a plant in the resources industry. The system 10 is arranged to monitor a large number of tags 12, typically in the form of sensors, that each provide operational information indicative of the functionality of an aspect of the plant. The system 10 also manages implementation of models associated with the tags 12 and also facilitates modification of the models by an operator. In the present example, the plant is a gas processing plant, although it will be understood that any facility, for example an operational facility in a resource or processing industry, is envisaged.

It will be understood that each model is arranged to carry out functionality in relation to at least one tag, for example to carry out analysis, validation, prediction and/or thresholding functions in relation to data obtained from a tag.

The system 10 includes a model implementer 14 arranged to implement models, and a model parameters storage component, in this example a model parameters storage database 16, arranged to store model parameters records 52, each model parameters record indicative of a model arranged to carry out defined functionality in relation to at least one tag 12.

The model implementer 14 instantiates packages of software on demand using application containers defined in application images.

An application container is a discrete, executable package of software for carrying out a specific task. The application container typically uses the host operating system kernel but otherwise includes all components required to run, including for example software code, runtime components, system tools, system libraries and settings.

In this example, the application containers are stateless containers 53 and, as such, data used by and produced by the container is not stored in the container. However, it will be understood that other types of application container are envisaged, for example stateful containers that store some data but otherwise store data used by and produced by the container outside of the container.

The stateless containers 53 are loaded from a stateless container storage device 17. Each stateless container defines a container image that is executed by the model implementer 14.

It will be understood that by using application containers it is possible to provide discrete packages of software that are used to carry out specific functionality (core and non-core) of a model whilst providing a suitable computing environment for implementing the functionality. For example, a model that requires a python, R or matlab environment can be implemented by providing an application container with the appropriate python, R or matlab environment.

In this example, the model implementer 14 is implemented using software “docker” provided by Docker, Inc., although it will be understood that any other suitable software arranged to manage and execute suitable application containers is envisaged.

It will be understood that each stateless container 53 is associated with one model family which may be associated with one or more model parameters records 52 and therefore one or more models. In this sense, each stateless container 53 provides a preconfigured native model implementer 14 that can be used by any model in the associated model family.

A model family is a grouping of similar or related models whose source code is treated as a unit for version control purposes by the module editor 46. Committing new code creates a new stateless container 53 for use by any member of the model family. It will be understood that the ability to specify different stateless containers 53 for a model parameter record 52 affords the ability to roll-back environment upgrades for individual models whilst leaving the upgraded environment accessible to other models in the same model family. It also enables the ability to concurrently run past versions of models so as to reproduce output of superseded model versions.

The system 10 also includes a model modules storage component 18 arranged to store model modules 19 that are associated with the model parameters records 52. Each model module 19 is arranged to implement core functionality of a model, that is, functionality such as analysis, validation, prediction and/or thresholding functions in relation to data obtained from at least one tag. Typically model modules 19 are implemented using software code computing environments such as R, python and matlab.

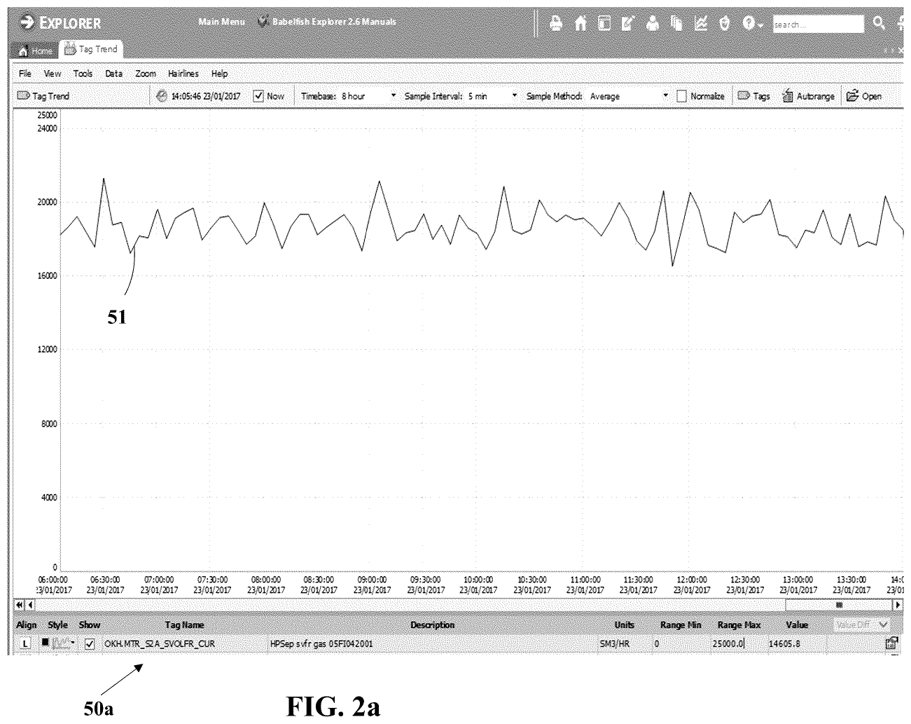

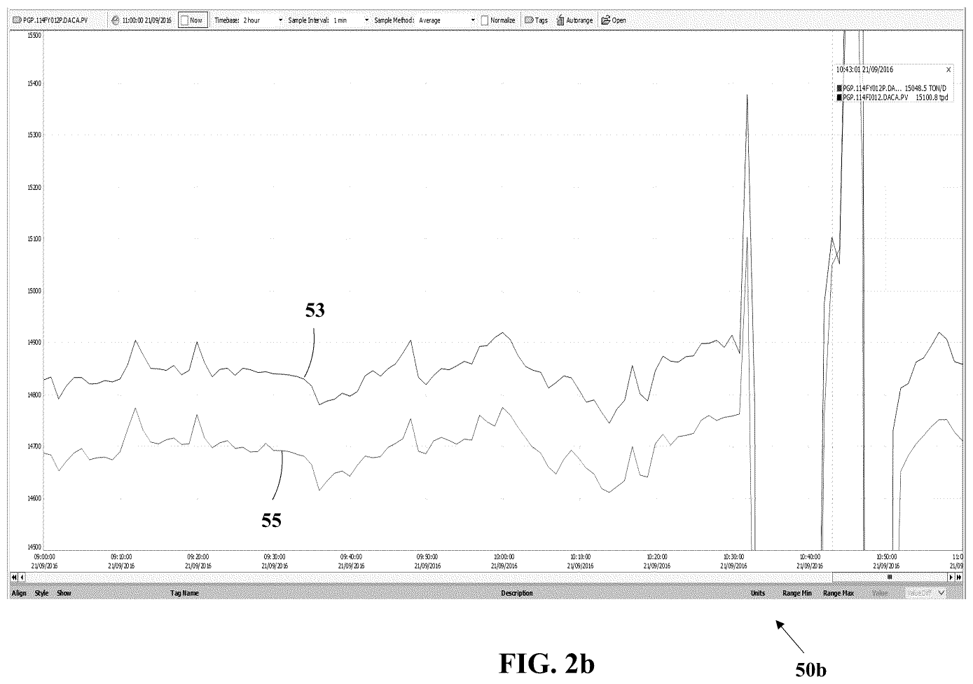

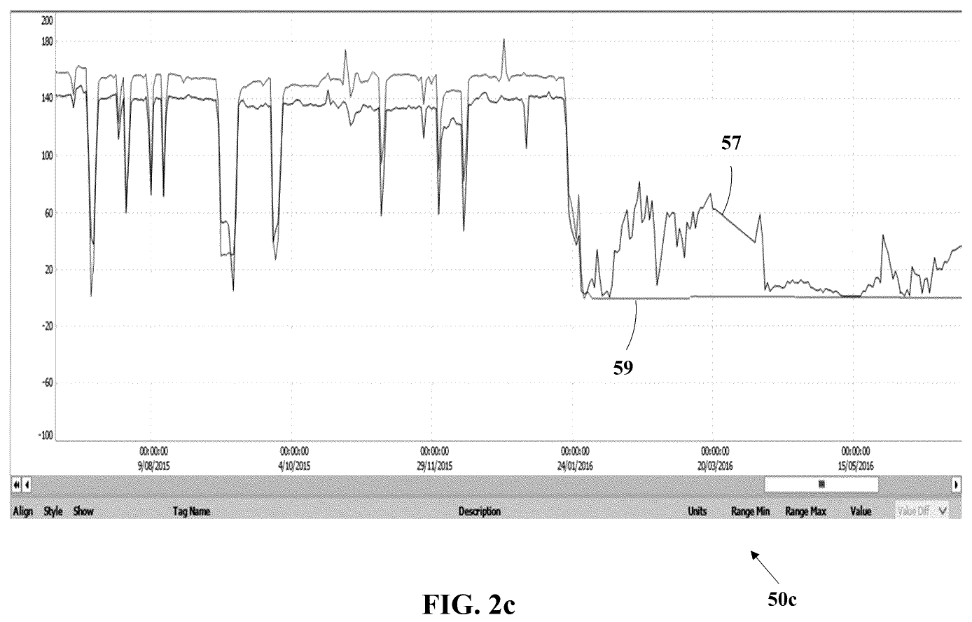

For example, in an example model for determining whether data from a high pressure fuel gas flow rate sensor is likely to be valid, the model module 19 may implement core functional code arranged to compare the data from the sensor with threshold values and output a result. Example data from such a sensor is shown in a plots 50a, 50b and 50c in FIGS. 2a, 2b and 2c, the plots representing fuel gas flow rate values measured by the sensor. When sensor values are summed over a significant period, such as a quarter year, to a single value, an operator cannot know whether the data points summed were individually plausible. As a consequence, it is necessary to implement a model having a model module that is arranged to identify whether individual sensor values are highly unlikely to be correct. For example, if a sequence of sensor values becomes perfectly steady, then the sensor values are unlikely to be correct, and a model including a suitable model module may be implemented to monitor this.

An example plot illustrating a fuel gas flow rate value 51 measured by an operational sensor is shown in FIG. 2a. FIG. 2b shows an example plot of fuel gas flow rate values 53, 55 measured by the sensor when the sensor is behaving abnormally and producing erratic values. FIG. 2c shows an example plot of fuel gas flow rate values 57, 59 measured by the sensor when the sensor is behaving abnormally and an output value 59 has flatlined.

In the present example, the model module 19 operates on data obtained from one tag 12, although it will be understood that a model module 19 may operate on data received from multiple tags 12.

It will also be understood that typically a model module 19 is arranged to perform 1 core function in relation to at least one tag, so that the model modules 19 can be kept simple and dedicated to a single function, and more easily used by other models. Such other models may be implemented using a different computing environment.

It will be understood that separating complex activities into individual core functions in this way, with the core functions implemented as individual model modules 19, permits the use of optimum computing environments for each model module 19.

It will be understood that each model module 19 may be associated with one or more model parameters records 52 and therefore one or more models. In this sense, each model module 19 performs a dedicated core function that can be used by any model.

The system 10 also includes a scheduler 20 arranged to call models at a time or regularity defined in timing information contained in the model parameters records 52 stored in the model parameters database 16.

The system 10 also includes a model inputs data storage component, in this example a model inputs database 22, arranged to store input data to be used by a model implemented by the model implementer 14 in an input record 80; a data gatherer 24 arranged to obtain data from the tags 24 and store the obtained data in the model inputs database 22; and a model outputs data storage component, in this example a model outputs database 26, arranged to store output data produced by implementation of a model module on input data stored in the model inputs database 22 in an output record 90.

It will be understood that a single model inputs database 22 may be provided for storing input data obtained from multiple tags 12 for use by multiple models, or alternatively multiple model inputs databases 22 may be provided, for example a different inputs database 22 for each tag 12, each model module 19 or each model.

Similarly, it will be understood that a single outputs database 26 may be provided for storing output data produced by implementation of multiple model modules 19 on input data stored in the model inputs database(s) 22, or alternatively multiple outputs databases 26 may be provided, for example a different outputs database 26 for each model or each model module 19.

It will also be understood that one or more common databases may be provided for storing both input and output data. Such a common database may for example be used for models that have as a sole purpose to provide input data to other models, wherein the model uses input data stored in the common database and writes output data back to the same common database for use by other dependent models.

The system 10 also includes a common functions storage component 27 arranged to store common functions 28 available for use by the model. The common functions 28 may for example carry out non-core functions, such as deployment functions, including housekeeping 30, data handling 32, pre-processing 34, validation 36, post-processing 38, error handling 40 and/or logging 42 functions.

In this example, the housekeeping function 30 is arranged to validate parameters for the call; verify that enough information to perform the operation was given; verify that information is in an understandable format; identify whether a time range has been prescribed and, if not, determine an appropriate time range; verify the time range is valid; and/or verify a set of model parameters can be retrieved for a parameter combination.

In this example, the data handling function 32 is arranged to load and validate an input dataset from an input record 80 specified in an input tag list defined in the relevant model parameters record 52 for the time range prepared by the housekeeping function 30; and subsequently determine and assign class types.

In this example, the pre-processing function 34 is arranged to implement standard activities such as sanitising illegal character combinations from data sources; carry out optional functions specified in the relevant model parameters record 52. Optional pre-processing may include removing encoded attributes from column names, implementing time-bound missing data recovery methods such as Last-Observation-Carried-Forward, implementing rolling medians and implementing missing data row omission.

In this example, the validation function 36 ensures that empty datasets are not written to the model outputs database 26; and undertakes mapping of authorised columns to model-version key pair outputs listed in the relevant model parameters record 52. Unauthorised columns are discarded.

In this example, the post-processing function 38 is arranged to implement optional data smoothing functions specified in the relevant model parameters record 52, such as implementing a time-bound Last-Observation-Carried-Forward function, implementing a rolling median, and implementing missing data row omission.

In this example, the error handling function 40 is arranged to wrap all other activities to capture their message output, verify processing, generate formatted error messages and control the continuation of processing.

In this example, the logging function 42 is arranged to receive status messages from function progress and error handlers, prepares processing run logs and posts messages to third party performance monitoring tools on the progress of processing steps.

It will be understood that the present model parameters storage component 16, model modules storage component 18 and common functions storage component 27 may be implemented using separate data storage devices that may include distributed file systems, or alternatively at least some of the model parameters 16, model modules 18 and common functions storage components 27 may be implemented using the same data storage device.

The system also includes a module editor 46 arranged to facilitate creation and/or modification of model modules by an authorised operator, and a display 48.

In this example, the system 10 is implemented using a computing device such as a personal computer, and the model modules 19 and custom functions 28 are implemented using one or more suitable software processes executed by a processor of the personal computer.

The present embodiment is implemented in relation to a resources plant with some components of the system 10 locally disposed at the resources plant, some components of the system disposed remotely from the plant, and the components connected together using any suitable communications arrangement, including an Ethernet network, wireless network, Bluetooth communications links, and so on. In this example, the components are connected together using a private cloud computing infrastructure, although it will be understood that other arrangements are envisaged.

In the present embodiment, the data gatherer 24 and tags 12 are disposed at the processing plant, and the data gatherer 24 provided with communication capability that facilitates data communications, for example through the Internet, to other system components that are disposed remotely from the processing plant. With this example, therefore, the main functional components of the system 10 may be disposed in a metropolitan area and arranged to communicate, for example using a private cloud-based infrastructure arrangement, with a processing plant disposed in a location remote from a metropolitan area.

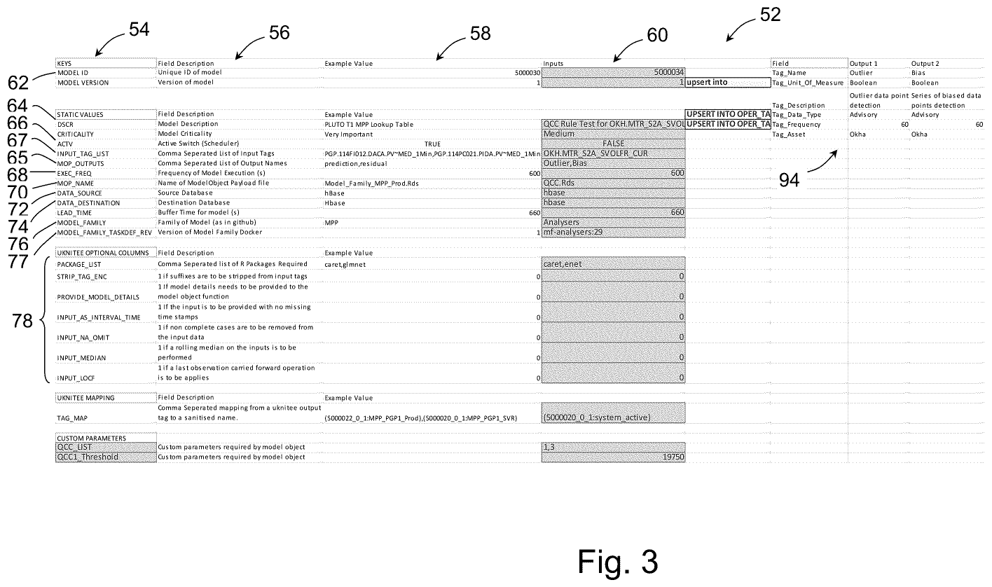

An example model parameters record 52 stored in the model parameters database 16 is shown in FIG. 3. The model parameters record 52 includes information that defines a model, the information being used by the model implementer 14 to implement the model when the model has been called by the scheduler 20.

In this example, the model parameters record 52 includes data fields 54; field description fields 56 that include information describing the data field content; example value fields 58 that include example information of the type intended to be included in the data fields; and default fields 60 that include default data field content should content be required in a data field but no content has been specified by an operator.

The data fields 54 include a MODEL_ID field 62 that includes unique information indicative of the model associated with the record 52; a DSCR field 64 that includes information describing the model, for example information describing the desired functionality of the model, in this example a ‘QCC Rule Test’; a MOP_OUTPUTS field 65 that defines a list of model object payload output fields corresponding to fields of the output record 90 that will be used by the model; an INPUT_TAG_LIST field 67 that specifies the tag(s) 12 associated with the model; an ACTV field 66 that indicates whether the model is active and therefore whether the model can be called by the scheduler 20; an EXEC_FREQ field 68 that includes information indicative of the frequency at which the model is to be called by the scheduler 20; a MOP_NAME field 70 that indicates the name of the model module(s) that is/are to be retrieved from the model modules database 18 and executed by the model implementer 14; a DATA_SOURCE field 72 indicative of the database from which input values are to be extracted and used by the executed model module(s); a DATA_DESTINATION field 74 indicative of the database to which output values produced by the executed model are to be stored; and a MODEL_FAMILY field 76 that includes information describing the family of models that the present model is part of.

A model family is a grouping of similar or related models whose source code is treated as a unit for version control purposes by the module editor 46. Committing new code creates a new stateless container 53 for use by any member of that model family. The MODEL_FAMILY field 76 determines which model family version is used.

The data fields 54 also include optional data fields, in this example including a PACKAGE LIST field, a STRIP_TAG_ENC field, a PROVIDE MODEL DETAILS field, an INPUT_AS_INTERVAL_TIME field, an INPUT_NA_OMIT field, an INPUT_MEDIAN field, and an INPUT_LOCF field. These fields contain information usable by the model implementer 14 to perform one or more common functions 28. Additional optional data fields are passed to the model module 19 as custom parameters to allow adjustment of thresholds and/or reuse of a model module 19 in multiple modules with action determined by one or more of the custom parameters.

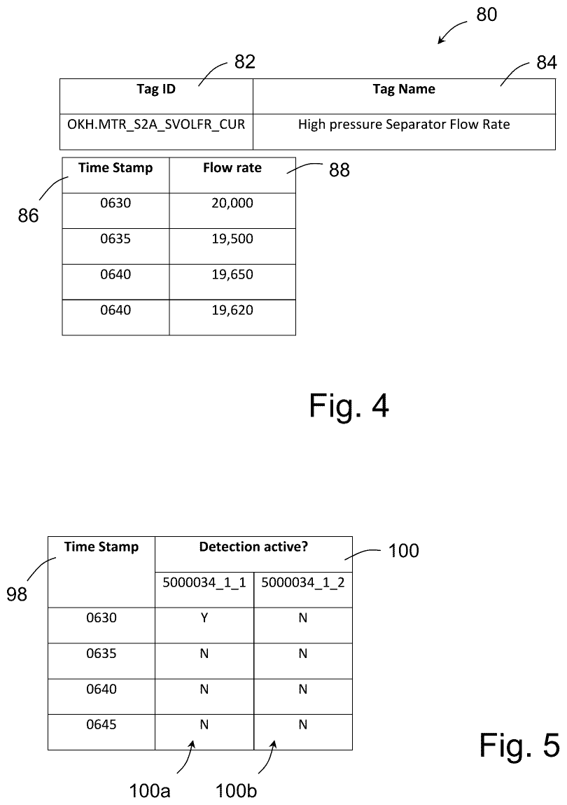

An example input record 80 stored in the model inputs database 22 is shown in FIG. 4. The input record 80 stores tag values obtained from at least one tag 12 by the data gatherer 24, and in this example includes a Tag ID field 82 that identifies the name of the tag 12 from which the input values are to be obtained; a tag name field 84 that includes information describing the tag 12; a time stamp field 86 that includes information indicative of the time at which a value was obtained from the tag 12; and a value field 88, in this example a flow rate value, that includes the value obtained from the tag 12 at the time indicated in the associated time stamp field 86.

An example output record 90 stored in the model outputs database 26 is shown in FIG. 5. The output record 90 stores output values produced by implementation of a model module 19 on data from an input tag 12 stored in the model inputs database 22. In this example, the output record 90 inherently identifies the name and version of the model that produced the output values in output data fields 100, in this example by virtue of first and second output fields 100a, 100b corresponding to tag output fields 94 defined in the relevant model parameters record 52 shown in FIG. 3, and the output field header including a portion corresponding to a unique model ID number, a portion corresponding to a model version number, and a portion corresponding to the output number; and a time stamp field 98 that includes information indicative of the time at which the input values were obtained from the tag 12. In this example, the output fields are ‘detection active?’ fields 100a, 100b defined in the tag output fields 94 of the model parameters record 52 as ‘outlier data point detection’ and ‘series of biased data points detection’.

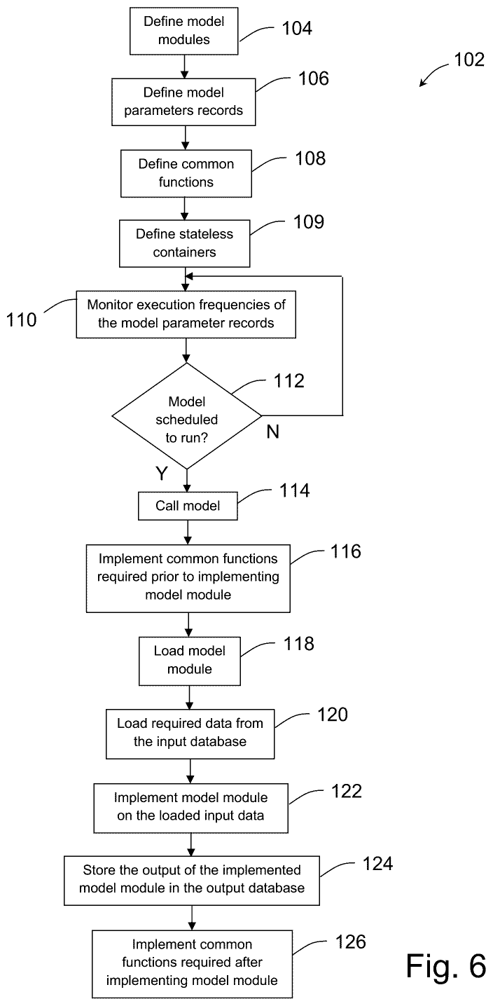

An example implementation of the model management system 10 will now be described during use in relation to flow diagram 102 shown in FIG. 6 that describes steps 104-126 of a model management process.

Prior to commencing operation of the model management system 10, model parameters records 52 indicative of models that carry out defined functionality in relation to tags of a plant, model modules 19 arranged to implement core functionality of a module, and common functions 28 arranged to implement non-core functions such as deployment functions, are defined 104, 106, 108 and stored in the respective model parameters database 16, model modules database 18 and common functions storage component 27. Stateless containers 53 are also defined 109 for the models and stored in the stateless container storage device 17, each stateless container defining the environment and components required to implement a model.

During operation, the scheduler 20 monitors the model parameters records 52 in the model parameters database 16 and, using the EXEC_FREQ field 68, monitors 110 the model parameters records 52 so as to determine when the respective models associated with the model parameters records should be run. When the EXEC_FREQ field 68 indicates that a model should be run, the scheduler 20 calls 114 the model, which causes a model implementer 14 to be instantiated on demand from a stateless container 53 loaded from the stateless container storage device 17, and the model defined by the associated model parameters record 52 to be implemented by the model implementer 14.

When a model is implemented by the model implementer 14, any required pre-processing common modules 28 are implemented 116 prior to implementation of the relevant model module, and after implementation of the pre-processing common modules 28, the model module(s) 19 defined in the MOP_NAME field 70 of the model parameters record 52 is implemented 122. Implementation of the relevant model module 19 causes input data values for a tag 12 associated with the model module 19 to be extracted 120 from the model inputs database 22, the functionality defined by the model module 19 to be implemented 122 on the extracted input data values, and output values produced by implementation of the model module 19 to be stored 124 in the model outputs database 26. After implementation of the model module 19, any required post-processing common modules 28 are implemented 126.

This process occurs for each model called by the scheduler 20.

The output data in the model outputs database 26 is typically analysed using suitable software and relevant analysis and reporting functions carried out, and for example displayed to an operator or generate advisory messaging.

It will be understood that since the core functionality of a model is implemented by model modules 19 and non-core functionality is implemented by common functions 28, with the model modules 19 separate to the common functions 28, and implementation of the core and non-core functions coordinated by virtue of the model parameters records 52, it is possible to modify core functionality of a model simply by modifying the relevant model module 19. In this way, instead of the current time consuming quality control process whereby the entire model code, including core function related code and non-core function related deployment code, is required to be reviewed and approved, only the code relating to the model module 19 needs to be reviewed. This greatly simplifies the deployment and maintenance of model code.

It will also be understood that by using application containers it is possible to provide the appropriate software environment for each model in an efficient, scalable way.

Using the module editor 46, an operator is able to directly modify a model module 46, for example so as to modify parameters of the model such as threshold values of the model, and thereby modify the model(s) (specified by the model parameter record(s) 52) that include(s) the model module 19.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Modifications and variations as would be apparent to a skilled addressee are deemed to be within the scope of the present invention.

What is claimed:

1. A model management system for managing models that are implemented by a processor to carry out at least one function on data obtained from at least one tag positioned in a facility, each tag producing data associated with operation of a process carried out in the facility, the system comprising:
a processor;
a first storage component that stores data indicative of a plurality of model modules, each model module configured to implement a core function of a model in relation to data obtained from at least one tag, wherein each model module is associated with one or more models;
a second storage component that stores data indicative of a plurality of non-core functions, each non-core function configured to implement a non-core function used by one or more models;
a third storage component that stores a plurality of model parameters records, each model parameters record comprising information that defines a model, the information being indicative of:
one or more model modules to use to implement the defined model;
any one or more non-core functions for the model; and
timing information;
and
a fourth storage component that stores a plurality of application containers, each application container defining a computing environment and components required for implementing one or more specific models;
wherein the first, second, third and fourth storage components are separate storage components, and
wherein the processor implements a model responsive to timing information defined in a model parameters record by:
utilizing, from the third storage component, the model parameters record including information defined for the model;
utilizing, from the fourth storage component and based on the utilized model parameters record, an application container, the application container providing a computing environment and components required for implementing the model;
implementing, from the first storage component, at least one model module defined in the utilized model parameters record for the model to execute the one or more core functions associated with each of the at least one model module on the data obtained from the at least one tag; and
implementing, from the second storage component, one or more non-core functions associated with the model to execute the one or more non-core functions defined for the model in the utilised model parameters record.

2. A model management system as claimed in claim 1, wherein the timing information is indicative of when the processor is to implement the model.

3. A model management system as claimed in claim 1, wherein at least some model parameters records include information indicative of whether the model associated with the utilized model parameters record is active or inactive, wherein the processor does not implement the model when the model parameters record includes an inactive indication.

4. A model management system as claimed in claim 2, further comprising a scheduler arranged to schedule implementation of the model associated with the utilized model parameters record, the scheduler being arranged to cause the processor to implement the model associated with the utilized model parameters record using the timing information in the utilized model parameters record.

5. A model management system as claimed in claim 1, wherein the application container is a stateless container.

6. A model management system as claimed in claim 1, comprising a model inputs data storage component arranged to store input data to be used by at least one model implemented by the processor, wherein the input data is obtained from at least one tag, and the system comprises a data gatherer arranged to obtain input data from the at least one tag and store the data in the model inputs data storage component.

7. A model management system as claimed in claim 1, comprising a model outputs data storage component arranged to store output data produced by implementation of at least one model module.

8. A model management system as claimed in claim 1, comprising a common model data storage component arranged to store input data to be used by at least one model module implemented by the processor and output data produced by implementation of the model module.

9. A model management system as claimed in claim 1, wherein at least one tag includes a sensor.

10. A model management system as claimed in claim 1, wherein the system includes a module editor arranged to facilitate creation and/or modification of a model module.

11. A method of managing models that are implemented by a processor on data obtained from at least one tag positioned in a facility, each tag producing data associated with operation of a process carried out in the facility, the method comprising:
storing in a first storage component data indicative of a plurality of model modules, each model module configured to implement a core function of a model in relation to data obtained from at least one tag, wherein each model module is associated with one or more models;
storing in a second storage component data indicative of a plurality of non-core functions, each non-core function configured to implement a non-core function used by one or more models;
storing in a third storage component data indicative of a plurality of model parameters records, each model parameters record comprising information that defines a model, the information being indicative of:
one or more model modules to be implemented for the defined model;
any one or more non-core functions for the model; and
timing information;
storing in a fourth storage component a plurality of application containers, each application container defining a computing environment and components required for implementing one or more specific models; and
implementing a model by a processor responsive to timing information defined in a model parameters record;
wherein the first, second, third and fourth storage components are separate storage components, and
wherein implementing the model comprises:
utilizing, from the third storage component, the model parameters record including information defined for the model;
utilizing, from the fourth storage component and based on the utilized model parameters record, an application container providing a computing environment and components required for implementing the model;
implementing, from the first storage component and based upon the information from the utilized model parameters record, at least one model module defined for the model to execute the one or more core functions associated with the at least one model module on the data obtained from the at least one tag; and
implementing, based upon data obtained from the second storage component, one or more non-core functions associated with the model, wherein implementing the one or more non-core functions causes execution of one or more non-core functionalities of the model.

12. A method as claimed in claim 11, wherein the timing information is indicative of when the processor is to implement the model.

13. A method as claimed in claim 11, wherein at least some model parameters records include information indicative of whether the model associated with the model parameters record is active or inactive, wherein the processor does not implement the model when the model parameters record includes an inactive indication.

14. A method as claimed in claim 12, wherein the method further comprises scheduling implementation of the model associated with the model parameters record, the scheduling including implementing the model associated with the model parameters records using the timing information in the model parameters records.

15. A method as claimed in claim 11, wherein the application container is a stateless container.

16. A method as claimed in claim 11, comprising storing input data to be used by at least one model implemented by the processor in a model inputs data storage component, wherein the method comprises obtaining the input data from at least one tag and storing the data in the model inputs data storage component.

17. A method as claimed in claim 11, comprising storing output data produced by implementation of at least one model module in a model outputs data storage component.

18. A method as claimed in claim 11, comprising storing input data to be used by at least one model module implemented by the processor and output data produced by implementation of the model module in a common model data storage component.

19. A method as claimed in claim 11, wherein at least one tag includes a sensor.

20. A method as claimed in claim 11, comprising facilitating creation and/or modification of a model module.
